(19) United States
(12) Patent Application Publication
(10) Pub. No.: US 2017/0114638 A1
(43) Pub. Date: Apr. 27, 2017

(54) MOUNTING ASSEMBLY FOR A CROSS-BAR OF AUTOMATED TEMPORARY ROOF SUPPORT

(71) Applicant: Caterpillar Global Mining America LLC, Houston, PA (US)

(72) Inventor: David M. Denson, Chennai (IN)

(73) Assignee: Caterpillar Global Mining America LLC, Houston, PA (US)

(21) Appl. No.: 14/922,206

(22) Filed: Oct. 26, 2015

(51) Int. Cl. E21D 19/00; F16C 11/04; E21D 20/00; F16M 13/02

(52) U.S. Cl. CPC E21D 19/00; F16M 13/02; F16C 11/04; E21D 20/00

(57) ABSTRACT

A mounting assembly for mounting a cross bar to a base, the mounting assembly including a hinge pin, the hinge pin configured to be vertically mounted on the base and pivotally support a cross bar, and a bracket for attachment to the base, the bracket having a first damper and a second damper arranged on either side of the hinge pin. The first damper and the second damper configured for compression by the pivoting of the cross bar on the hinge pin.

### TECHNICAL FIELD

Present disclosure relates to an automated temporary roof support of an underground mining machine. In particular, present disclosure relates to a mounting assembly for a cross bar of an automated temporary roof support.

### BACKGROUND

Roof bolter machines are generally used in mining industry for securing mine roofs to be self-supportive. Generally, there may be two types of operations that the roof bolters perform, namely, drilling operations and bolting operations. The drilling operations include drilling the roof and the bolting operations include inserting bolts such as cable bolts, or resin roof bolts, etc., and subsequently tightening the inserted bolts.

A mining machine includes an Automatic Temporary Roof Support (ATRS) for supporting the roof of a mine during roof bolting and other mining operations. In order to support the roof of the mine, the ATRS is raised and held proximate or against the roof of the mine

An ATRS may include a temporary roof support for the roof inside a mine. Generally a cross bar extending on either side of a base of the ATRS provides for temporary support to the roof. During movement of the machine, the cross bar may hit the roof surface or any other surface inside the mine. Such impact on the cross bar is transmitted to the base and may damage the base, the cross bar or mounting arrangement for the cross bar.

U.S. Pat. No. 5,983,376 discloses mounting a temporary roof support apparatus on a base. The bottom arms are mounted on the base using a bottom pin that permits the bottom arms to pivot vertically relative to the base. In the event of a side impact on the bottom arms, the impact forces are transmitted to the base, which may cause damage. An operator is required to inspect the temporary roof support apparatus for damage after each impact.

### SUMMARY OF THE INVENTION

A mounting assembly for mounting a cross bar to a base, the mounting assembly including a hinge pin, the hinge pin configured to be vertically mounted on the base and pivotally support a cross bar, and a bracket for attachment to the base, the bracket having a first damper and a second damper arranged on either side of the hinge pin. The first damper and the second damper configured for compression by the pivoting of the cross bar on the hinge pin.

An automated temporary roof structure for a machine system including a base, a cross bar pivotally mounted on the base, a hinge pin, the hinge pin configured to be vertically mounted on the base and pivotally support the cross bar and a bracket for attachment to the base, the bracket having a first damper and a second damper arranged on either side of the hinge pin. The first damper and the second damper configured for compression by the pivoting of the cross bar on the hinge pin.

A method of mounting a cross bar to a base, the method including damping movement of the cross bar up to a threshold pivot angle of the cross bar by a damper provided on a bracket of the base and pivoting the bracket along with the cross bar for a pivot angle of the cross bar greater than the threshold pivot angle.

### BRIEF DESCRIPTION OF THE DRAWINGS

FIG. 1 is a perspective view of a Roof Bolter machine having an ATRS shown in accordance with the concepts of the present disclosure.

FIG. 2 is a perspective view of the ATRS of FIG. 1, along with an enlarged perspective view of a mounting assembly of the ATRS shown in accordance with concepts of the present disclosure.

FIG. 3 is a cross-sectional view of the mounting assembly defined along a plane passing through the pivot pin axis and the longitudinal hinge pin axis, in accordance with the concepts of the present disclosure.

FIG. 4 is a partial perspective view of a cutaway of the mounting assembly shown in accordance with the concepts of the present disclosure.

FIG. 5 is a top view of the ATRS with a cross bar along with an enlarged top view of the ATRS in accordance with the concepts of the present disclosure.

FIG. 6 is a top view of the ATRS with the cross bar pivoted by an angle ‘B’ shown in accordance with the concepts of the present disclosure.

FIG. 7 is a top view of the ATRS with the cross bar pivoted by an angle ‘C’ shown in accordance with the concepts of the present disclosure.

FIG. 8 illustrate a method of mounting a cross bar on a base of an ATRS in accordance with the concepts of the present disclosure.

### DETAILED DESCRIPTION

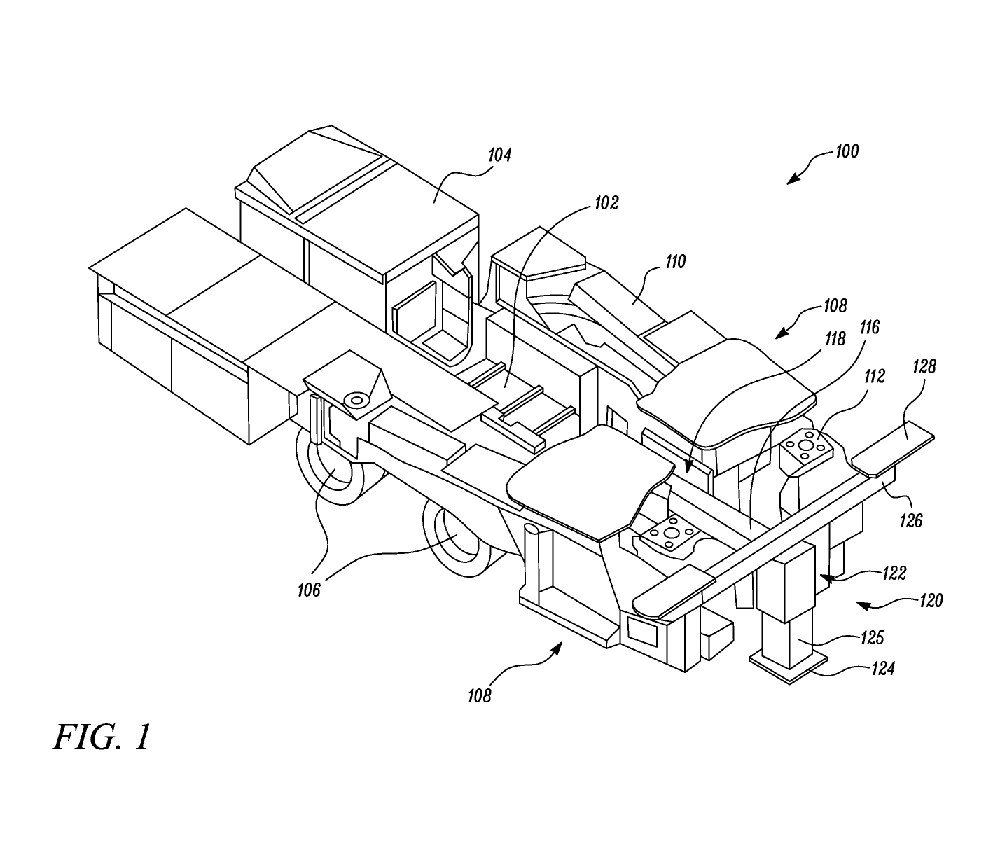

Referring to FIG. 1, an exemplary machine 100 is shown. The machine 100 may be a roof bolter. The machine 100 may be configured for supporting a section of roof of a mine and/or a tunnel during a roof bolting operation. The machine 100 may also be configured for performing the roof bolting operation using suitable rock drilling and bolting tools. It should be noted that the machine 100 may include any other machine having an implement. For example, the machine 100 may embody, a mining machine, a crane, an elevated work platform and the like.

The machine 100 includes a frame or a chassis 102. An enclosure 104 may be provided on the frame 102. The enclosure 104 houses a power source (not shown). The power source may be any conventional or non-conventional power source including, but not limited to, an internal combustion engine, power storage devices like batteries, electric motor and the like. The power source is configured to provide power to the machine 100 for mobility and/or other operational needs. The enclosure 104 may also house various other components required for operational control of the machine 100 including, but not limited to, electrical and/or electronic components, hydraulic and/or pneumatic components. Further, ground engaging members 106 such as wheels or tracks are provided on the machine 100 for the purpose of mobility. A drivetrain (not shown) is coupled to the power source and the ground engaging members 106. The drivetrain may include any one or a combination of, but not limited to, gearing, differentials, drive shafts and hydraulic and/or pneumatic circuits including valves, lines, distribution manifolds, electric drive machine, and the like. The drivetrain is configured to transmit power from the power source to the ground engaging members 106.

The machine 100 may be provided with a drill boom assembly 108. The drill boom assembly 108 may be pivotally coupled to the frame 102 of the machine 100. The drill boom assembly 108 may include an arm 110 in order to pivotally couple the drill boom assembly 108 to the frame 102 of the machine 100. The drill boom assembly 108 may include a drill assembly 112. The drill boom assembly 108 may be arranged to swing outwards, extend, contract, raise and lower by means of actuators. The drill assembly 112 may be configured to perform the rock bolting operation using suitable rock drilling and bolting tools. The drill boom assembly 108 may also include an operator platform 114. The operator platform 114 may be provided with various controls which may be used by an operator to control the drill boom assembly 108 and/or the machine 100. It should be noted that the drill boom assembly 108 may be replaced by any other implement such as, for example, a bucket, as per operational requirements.

Further, a horizontal boom 116 is provided on the machine 100. A rear end 118 of the horizontal boom 116 may be pivotally coupled to the frame 102 of the machine 100. An Automatic Temporary Roof Support (ATRS) 120, is provided on a front end 122 of the horizontal boom 116. The horizontal boom 116 may be configured as a telescopic boom having an extendable length in order to allow raising or lowering any implement mounted on the horizontal boom 116. In the embodiment shown in FIG. 1, the ATRS 120 is mounted and the horizontal boom 116 is configured for positioning of the ATRS 120 at a required location and distance with respect to the frame 102 of the machine 100, within the mine.

The ATRS 120 includes a base 124 coupled to a cross bar 126 provided with support pads 128. The base 124 may be configured as a telescopic column having an extendable length in order to raise or lower the cross bar 126 with respect to the machine 100. The base 124 includes an enclosure 125 that encases other components of the base 124, for example a multi-stage hydraulic cylinder.

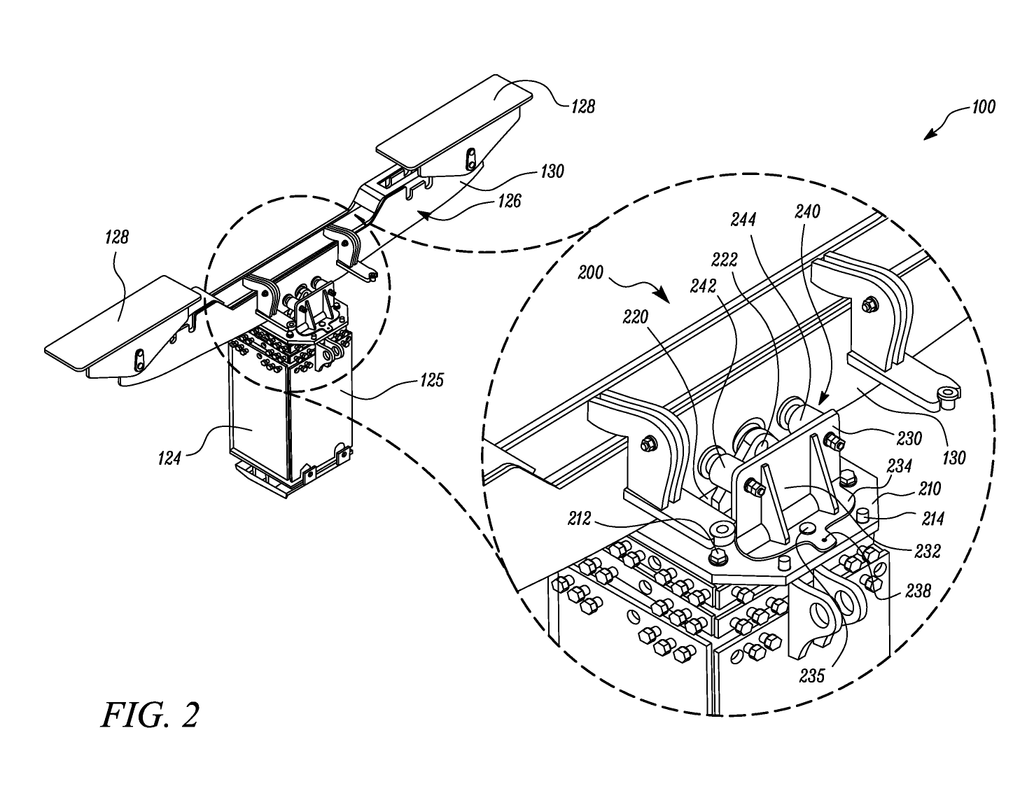

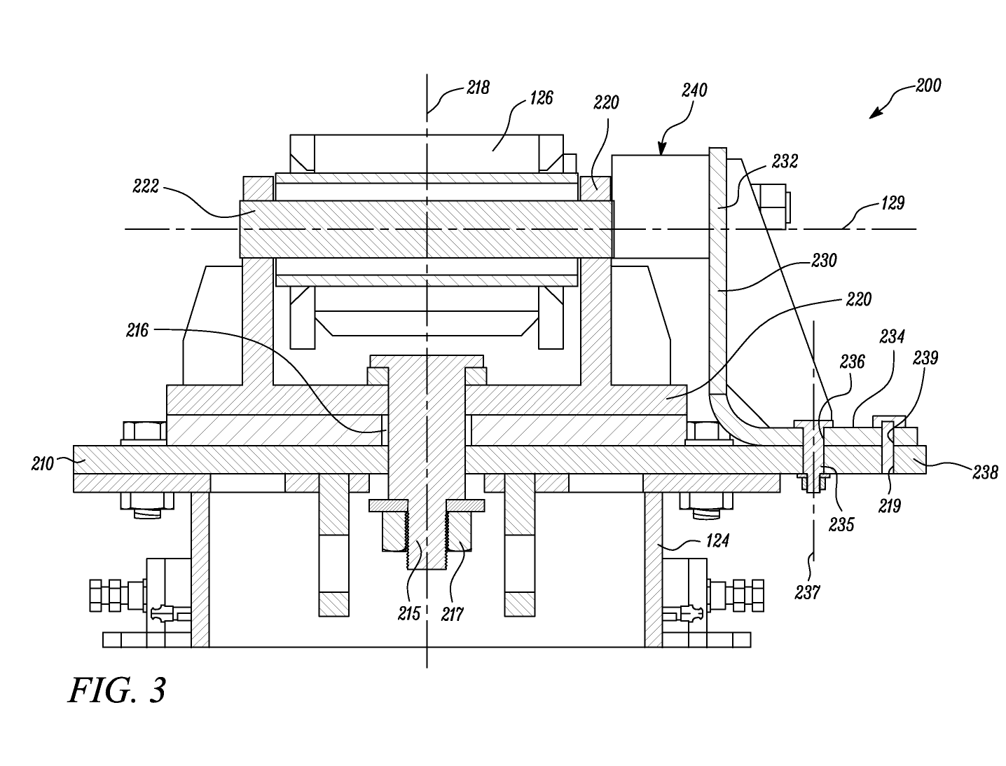

Referring to FIG. 2, the base 124 includes a base plate 210 attached to the base 124. The base plate 210 may be attached to the base 124 using any known method. In the embodiment as illustrated, the base plate 210 is attached to the base 124 using bolts 212. Further, the base plate 210 may define openings 213 configured to receive the bolts 212, as shown in FIG. 3. In an embodiment the openings 213 may be threaded openings or a nut welded to the base plate 210 to receive a screw or any other threaded component known in the art.

Referring to FIG. 3, the cross bar 126 includes a bottom plate 220 for coupling a pivot pin 222. The pivot pin 222 is oriented horizontally and allows for vertical pivoting of the cross bar 126 on a pivot pin axis 129. When the ATRS 120 is in the raised position, the support pads 128 are configured to rest against a section of the roof of the mine and provide support to that particular section of the roof. The cross bar 126 is configured to pivot on the pivot pin axis 129 for allowing any adjustment required in the relative height of the support pads 128 for supporting an uneven roof surface.

The cross bar 126 is coupled to the base 124 using a mounting assembly 200. The bottom plate 220 is coupled to the base plate 210 using a hinge pin 215. The hinge pin 215 is vertically mounted on the base 124 and allows for rotation of the cross bar 126 relative to the base 124 along a longitudinal hinge pin axis 218. A spacer 216 may be placed between the hinge pin 215 and the base plate 210. The spacer 216 may be configured to damp any relative movement between the base plate 210 and the bottom plate 220. FIG. 3 shows a cross sectional view of the mounting assembly 200 defined along a plane passing through the longitudinal hinge pin axis 218 and the pivot pin axis 129. In the embodiment as shown in FIG. 3, the spacer 216 may be a rubber pad, a polyurethane pad, or any known suspension pad in the art. Further, a lock 217 may lock the hinge pin 215 in position. In the embodiment as shown in FIG. 3, the lock 217 is a nut.

The mounting assembly 200 further includes a bracket 230 mounted on the base plate 210. The bracket 230 may be of ‘L’ shape and have vertical plate 232 and a horizontal plate 234. The bracket 230 is mounted on the base plate 210 using a mounting pin 235 received in an opening 236 in the horizontal plate 234 and the base plate 210. Further, the horizontal plate 234 defines a shear pin opening 239 and the base plate 210 defines a corresponding base plate opening 219 such that a shear pin 238 may be inserted in the shear pin opening 239 and the base plate opening 219 to restrict pivoting of the bracket 230 relative to the base plate 210 about the mounting pin axis 237. The mounting pin 235 allows the bracket 230 to pivot relative to the base plate 210 along the axis of the vertically oriented mounting pin 235 when the shear pin 238 is broken or removed. Further, the base plate 210 may be provided with two stoppers 214. The stopper 214 is configured to restrict the pivotal movement of the bracket 230 beyond a predetermined angle by blocking the movement of the horizontal plate 234. The angle at which the stopper 214 restricts the pivotal movement of the cross bar 126 is the bracket pivot angle. The bracket pivot angle may be an angle suitable to minimize the impact force transferred to the base 124.

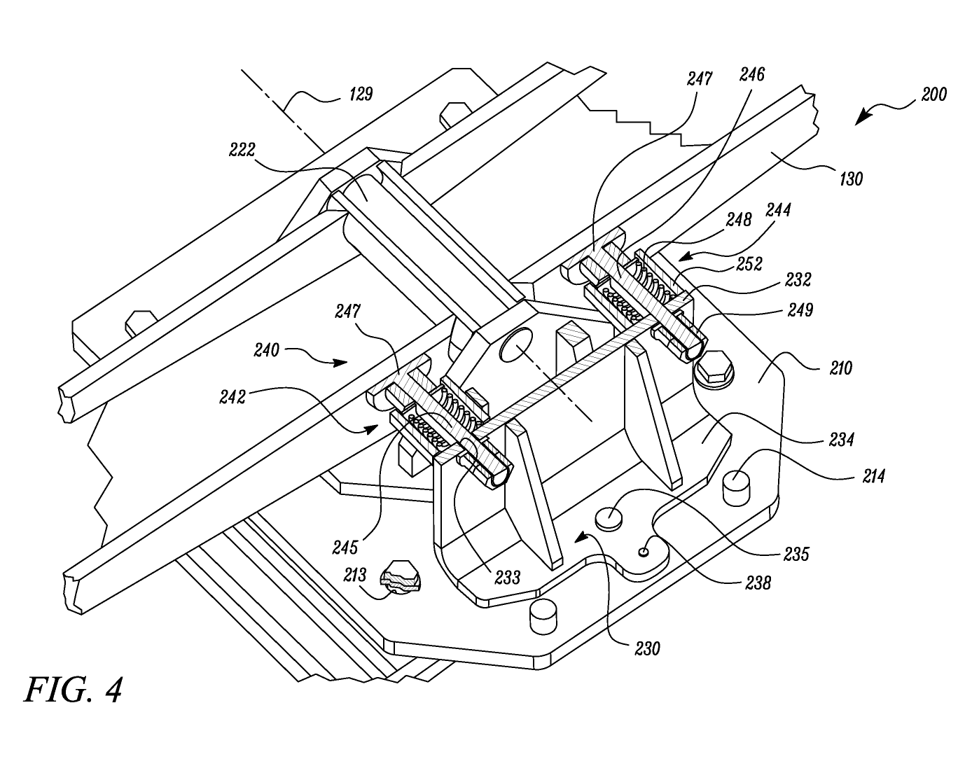

Further, referring to FIG. 4, the bracket 230 is mounted with a damping arrangement 240. The damping arrangement 240 is configured to damp the horizontal pivoting movement of the cross bar 126 about the hinge pin 215. Referring to FIG. 2, the damping arrangement 240 includes dampers 242, 244. In an embodiment, the dampers may have a first damper 242 and a second damper 244. The dampers 242, 244 may be any known dampers in the art. In the embodiment as illustrated, the dampers 242, 244 are spring dampers.

Referring to FIG. 4, each damper 242, 244 may include a stud 246 with a flange 247 at one end a stud shaft 245 with adjusters 249 at the other end. The stud shaft 245 may be received in a stud opening 233 in the vertical plate 232 of the bracket 230. A spring 248 is placed over the shaft 245 between the flanges 247 and the vertical plate 232. The dampers 242, 244 may further include a cover 252 to protect the spring 248 and the stud 246 against any debris or dust. The cover 252 may be attached to the vertical plate 232. The stud 246 has a flange 247 at one end and adjusters 249 at the other end. The adjusters 249 are configured to adjust the distance between the flange 247 and the vertical plate 232. The adjusters 249 may be any known arrangement in the art. In the embodiment as illustrated, the adjusters 249 are nuts that are mounted on the threads on the stud 246. Rotating the nuts on the stud 246 alters the distance between the flanges 247 and the vertical plate 232. Further, the flange 247 may have width or a diameter greater than the width or diameter of the cover 252 such that beyond a certain compression of the spring 248, the flange 247 may abut the covers 252.

The bracket 230 along with the dampers 242, 244 are mounted on the base plate 210 such that the two dampers 242, 244 are positioned proximate to the side surface 130 of the cross bar 126 on each side of the hinge pin 215. When the cross bar 126 is oriented in the normal position, the flanges 247 may abut the side surface 130 of the cross bar 126 such that any pivotal movement in the cross bar 126 about the hinge pin 215 will result in pushing of one of the flanges 247 and in turn compression of the springs 248. In alternate embodiments, the flanges 247 may be positioned at a distance from the cross bar 126. The springs 248 absorb any pivoting movement of the cross bar 126 till the flanges 247 abut the covers 252. This arrangement permits pivoting movement of the cross bar 126 along the hinge pin axis 218 upto a threshold angle without any damage. Any further pivoting movement in the cross bar 126 is transmitted to the bracket 230 that is prevented from movement by the shear pin 238. A threshold force acting on the bracket 230 may break the shear pin 238 and allow the bracket 230 to pivot on the mounting pin axis 237.

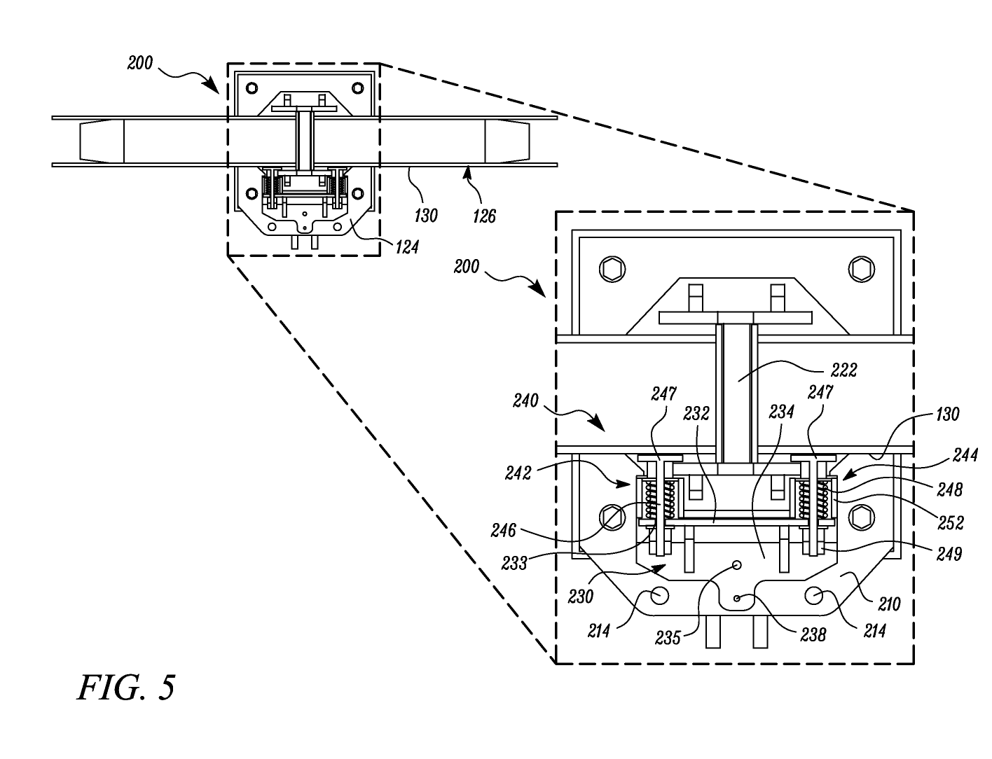

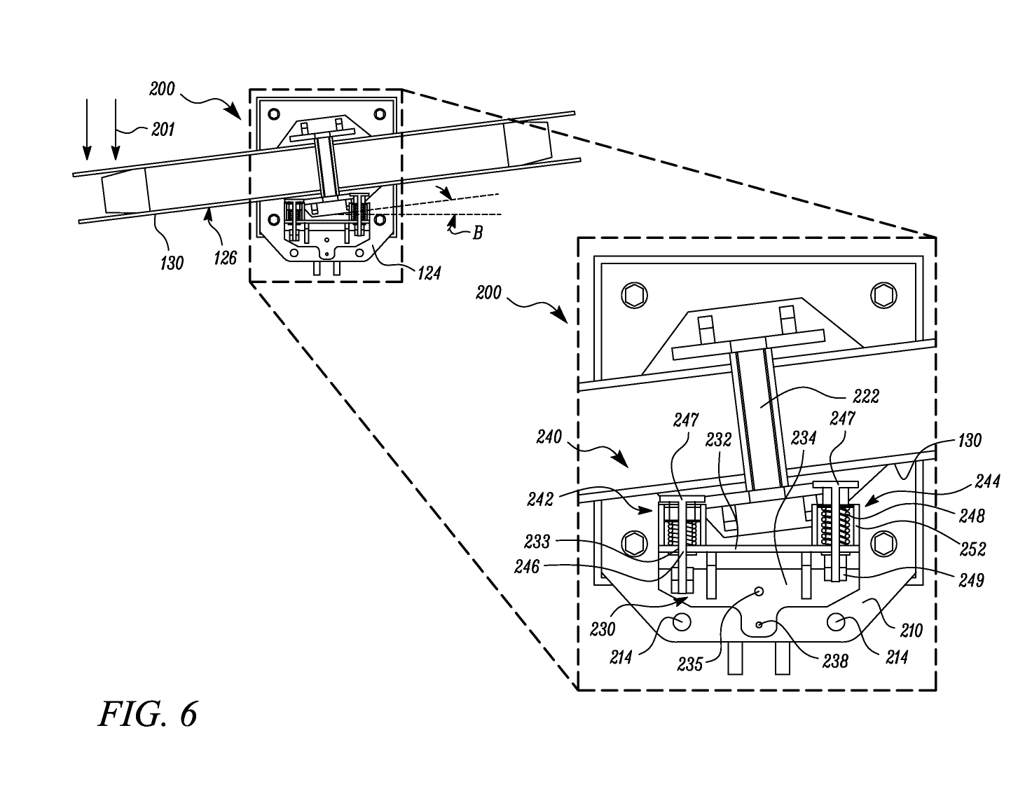

FIG. 5 shows a cross bar 126 in an operating position. In the operating position, the flanges 247 of the dampers 242, 244 abut the side surface 130 of the cross bar 126 and at a distance from the covers 252. Any impact on either side of the cross bar 126 may result in a pivotal movement of the cross bar 126 along the hinge pin 215 (FIG. 3). FIG. 6 shows the cross bar 126 pivoted by a first angle B in an anticlockwise direction by impact 201. In the embodiment as shown in FIG. 6, the first angle B is the threshold angle. Upon impact on either side of the cross bar 126, the damping arrangement 240 may absorb the pivoting movement of the cross bar 126 from the operating position up to the angle B by compression in the spring 248 of the one of the dampers 242, 244 against the vertical plate 232. In the embodiment shown in FIG. 6, the first damper 242 absorbs the anticlockwise pivotal movement of the cross bar 126. On pivotal movement in the cross bar 126, the side surface 130 of the cross bar 126 pushes the flange 247 against the bracket 230 to compress the spring 248. The bracket 230 is held in position by the mounting pin 235 and the shear pin 238. In case the pivotal movement of the cross bar 126 takes place in an opposite direction, i.e. clockwise direction, the second damper 244 will absorb the pivotal movement in the cross bar 126.

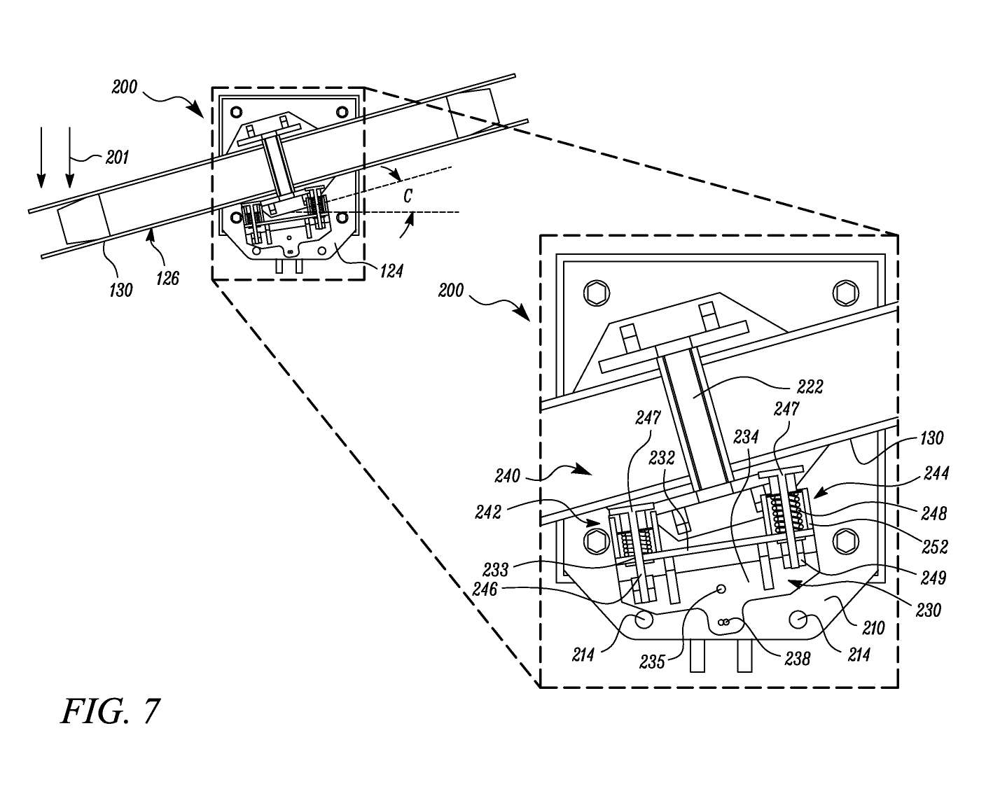

The spring 248 may get compressed up to a point where the flanges 247 abut the covers 252. Movement in the cross bar 126 beyond the angle B results in the cross bar 126 pushing against the bracket 230 and hence transferring the force of the impact 201 on the bracket 230. The shear pin 238 restricts the pivotal movement in the bracket 230 along the mounting pin axis 237. The shear pin 238 is configured to shear upon exposure to a shearing force greater than or equal to a threshold force. As shown in FIG. 7, pivoting of the cross bar 126 by a second angle C greater than the angle B exerts a shearing force greater than the threshold of the shear pin 238 causing the shear pin 238 to break and the bracket 230 to pivot about the mounting pin 235. The stoppers 214 block pivoting of the bracket 230 beyond the second angle C. This way the impact 201 on the cross bar 126 is absorbed by the compression in the dampers 242, 244 and subsequently by pivoting of the bracket 230 by breaking of the shear pin 238.

### INDUSTRIAL APPLICABILITY

During operation or movement of the ATRS 120, the cross bar 126 of ATRS 120 may hit a roof surface, side walls or any other surface in the mine. Such impact on the cross bar 126 may be transmitted to the base 124 and the ATRS 120 may get damaged. Present disclosure provides for a mounting assembly 200 for mounting a cross bar 126 to a base 124. Mounting the cross bar 126 in accordance with the present disclosure provides for a damping system for damping an impact 201 on the cross bar 126. The mounting assembly 200 damps the impact 201 and prevents any damage to the base 124 on account of transmittal of impact forces.

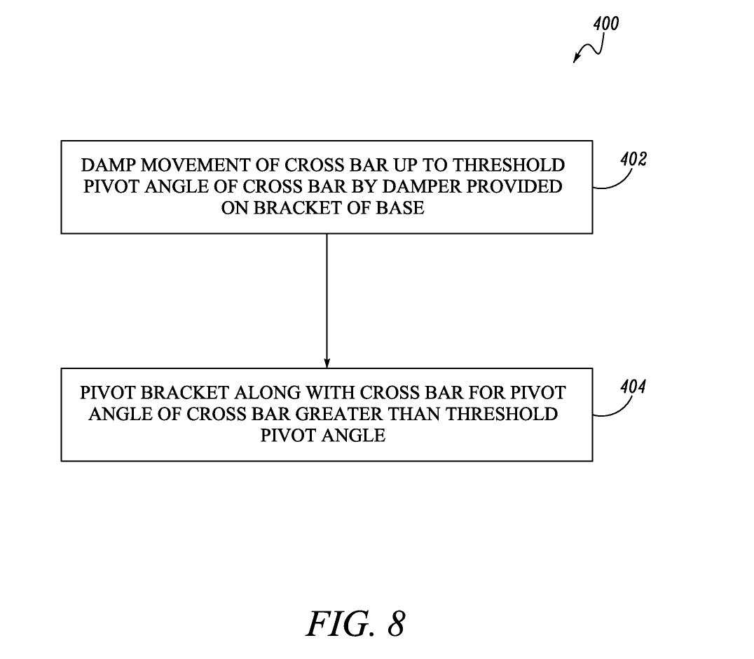

Further present disclosure provides for a method 400 of mounting a cross bar 126 to a base 124. As illustrated in FIG. 8, step 402 includes damping movement of the cross bar 126 up to a threshold pivot angle of the cross bar 126 by dampers 242, 244 provided on a bracket 230 of the base 124. The dampers 242, 244 arranged between the side surface 130 of the cross bar 126 and the bracket 230 mounted on the base 124 are configured to absorb the movement in the cross bar 126 about the hinge pin axis 218 upto a threshold pivot angle. In an embodiment, the method 400 further includes re-orienting the cross bar 126 by the dampers 242, 244 for a pivot angle of the cross bar 126 less than the threshold pivot angle. The cross bar 126 is reoriented by the dampers 242, 244 for impacts which pivot the cross bar 126 upto a first angle B. The springs 248 in the cross bar 126 restore the cross bar 126 to original position after the impact. The restoration of the cross bar 126 to its operational position by the dampers 242, 244 obviates the need for an operator inspection and intervention after each impact.

The step 404 includes pivoting the bracket 230 along with the cross bar 126 for a pivot angle of the cross bar 126 greater than the threshold pivot angle.

In an embodiment, the method 400 further includes pivoting the bracket 230 by breaking a shear pin 238 connecting the bracket 230 to the base 124. Movement in the cross bar 126 beyond the first angle B results in the cross bar 126 pushing against the bracket 230 and hence transferring the force of the impact 201 on the bracket 230. Under the force of the impact 201, the shear pin 238 is configured to shear upon exposure to a shearing force greater than or equal to a threshold force. After the shear pin 238 breaks, the bracket 230 pivots about the mounting pin 235. Thus, the movement of the cross bar 126 beyond the first angle B is allowed by breaking of shear pin 238 and the force of the impact is prevented from being transferred to the base 124. This way the base 124 or the cross bar 126 may be protected from any damage occurring due to the impact 201.

In an embodiment, the method 400 further includes restoring the cross bar 126 by replacing the shear pin 238 for a pivot angle of the cross bar 126 greater than the threshold pivot angle. The cross bar 126 may be restored to its normal operating position by aligning the base plate opening 219 with the shear pin opening 239 and replacing the shear pin 238 to reorient the bracket 230 and the cross bar 126. As the ATRS 120 can be put back into operation by replacement of a shear pin 238, present disclosure provides for a cost effective solution for averting damage in the ATRS 120 due to horizontal impacts on the cross bar 126. In another embodiment, the method 400 further includes stopping pivoting of the bracket 230 at a bracket pivot angle C.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting assembly for mounting a cross bar to a base, the mounting assembly comprising:
a hinge pin, the hinge pin configured to be vertically mounted on the base and pivotally support a cross bar; and
a bracket for attachment to the base, the bracket having a first damper and a second damper arranged on either side of the hinge pin, the first damper and the second damper configured for compression by the pivoting of the cross bar on the hinge pin.

2. The mounting assembly of claim 1, further comprising a shear pin, the bracket mounted to the base with the shear pin.

3. The mounting assembly of claim 1, further comprising a pivot pin to pivotally mount the bracket on the base.

4. The mounting assembly of claim 1, further comprising a stopper mounted on the base to limit the pivot of the bracket beyond a predetermined angle.

5. The mounting assembly of claim 1, wherein the first damper and the second damper abut the cross bar.

6. The mounting assembly of claim 1, wherein the first damper and the second damper have adjusters to adjust orientation of the cross bar.

7. The mounting assembly of claim 1, further comprising a hinge pin damper placed between the hinge pin and the cross bar.

8. An automated temporary roof structure for a machine system comprising:
a base;
a cross bar pivotally mounted on the base;
a hinge pin, the hinge pin configured to be vertically mounted on the base and pivotally support the cross bar; and
a bracket for attachment to the base, the bracket having a first damper and a second damper arranged on either side of the hinge pin, the first damper and the second damper configured for compression by the pivoting of the cross bar on the hinge pin.

9. The mounting assembly of claim 8, wherein the bracket is mounted to the base with a shear pin.

10. The mounting assembly of claim 8, wherein the bracket is mounted to the base with a pivot pin.

11. The mounting assembly of claim 8, wherein the base comprises a stopper to limit pivot of the bracket beyond a predetermined angle.

12. The mounting assembly of claim 8, wherein the first damper and the second damper abut the cross bar.

13. The mounting assembly of claim 8, wherein the first damper and the second dampers have adjusters to adjust orientation of the cross bar.

14. The mounting assembly of claim 8, wherein a hinge pin damper is placed between the hinge pin and the base.

15. The mounting assembly of claim 8, wherein the dampers are configured to absorb a predetermined pivot of the cross bar.

16. A method of mounting a cross bar to a base, the method comprising:
damping movement of the cross bar up to a threshold pivot angle of the cross bar by a damper provided on a bracket of the base; and
pivoting the bracket along with the cross bar for a pivot angle of the cross bar greater than the threshold pivot angle.

17. The method of claim 16, further comprising pivoting the bracket by breaking a shear pin connecting the bracket to the base.

18. The method of claim 16, further comprising re-orienting the cross bar by the damper for a pivot angle of the cross bar less than the threshold pivot angle.

19. The method of claim 16, further comprising restoring the cross bar by replacing the shear pin for a pivot angle of the cross bar greater than the threshold pivot angle.

20. The method of claim 16, further comprising stopping pivoting of the bracket at a bracket pivot angle.
